(19) United States
(12) Patent Application Publication
(10) Pub. No.: US 2014/0358783 A1
(43) Pub. Date: Dec. 4, 2014

(54) SYSTEMS AND METHODS OF GENERATING AND PROCESSING PAYMENT TRANSACTIONS USING ALTERNATE CHANNELS AND PAYMENT MODE

(71) Applicant: Nuspay International Incorporated, Coppell, TX (US)

(72) Inventor: Md. Abul MANSUR, Dhaka (BD)

(73) Assignee: NUSPAY INTERNATIONAL INCORPORATED, Coppell, TX (US)

(21) Appl. No.: 14/251,241

(22) Filed: Apr. 11, 2014

Related U.S. Application Data
(60) Provisional application No. 61/972,280, filed on Mar. 29, 2014.

(51) Int. Cl. G06Q 20/32; G06Q 20/40; G06Q 20/10

(52) U.S. Cl. CPC G06Q 20/322; G06Q 20/10; G06Q 20/40
USPC 705/44; 705/39

(57) ABSTRACT

Systems and methods generate and process payment transactions using a virtual account for payment transaction which is generated and transmitted to a customer registered mobile device. The virtual account with a limited lifetime with single or multi use purpose is created for the associated bank account number and generated on-demand by the registered customer upon authentication which may be communicated using SMS, IVR, USSD, Mobile Apps, Smart Apps or NFC protocols to the registered mobile number for immediate use for payments which can be used for online purchasing, peer to peer payments, automatically read-out or to manually enter at a point of sale. The system also creates virtual point of sale (POS) to a substitute for hardware based POS payment devices during check out at a physical store to facilitate for accepting payments in different modes.

This Application claims priority to U.S. Provisional Application Ser. No. 61/972,280 filed Mar. 29, 2014, which is incorporated herein by reference in its entirety.

### FIELD

The present disclosure generally relates to systems and methods of secure payment and transactions and more particularly, to systems and methods of on-demand virtual account number generation with a limited lifetime for one time use communicated over mobile devices for immediate use for payments associated with a bank account for online purchasing, Peer to Peer Payments or to manually enter or to automatically read-out at a point of sale for purchases.

### BACKGROUND

For operators of a payment network and providers of services over communication networks, protection of the payment account number is an increasingly important function. Payment account number theft and fraud are serious crimes which can cost companies millions of dollars every year, and can affect individuals and a wide range of enterprises, including online retailers, insurance companies, healthcare companies, and financial institutions, among others. Exchanging hard cash in public places are also dangerous as people are targeted by robbers. Robbery in the store, road, and other open or public places are rising and each year, thousands of people are getting killed by the robber to get cash. Express services are also getting hindered and the cash queue grows even bigger when the cash operator needs to provide small changes to the customers. Self-service checkout or service outlets want to reduce the burden of cash counter operators during holidays rush to the supermall or financial institutions.

Electronic Payments using a bank account are an efficient and cost-reducing alternative to paper checks, cash, and credit and debit cards. On the Internet, bank account payments are primarily used for person-to-person (P2P), business-to-customer (B2C), and business-to-business (B2B) payments. However providing a bank account number to the beneficiary to debit the account leads to exposure for misuse or fraudulent activities.

With the increase of e-commerce/online transactions, the systems which process payments have been a target for attacks from fraudsters and hackers. Several solutions intended to de-risk the exposure of personal account numbers have been developed and deployed by various institutions. One such option has been use of virtual account numbers which allow customers to perform online transactions without having to use their actual card number.

Though the systems, a substitute single-use credit card number is generated for secure online purchasing. To obtain a virtual account number, the customer has to visit the website to obtain a new virtual account number or alternatively, downloads a virtual account number generator to the user's computer. Some virtual account numbers have to be initiated by the merchant to create a token to generate a new number for the cardholder.

Also with the increase in use of bank accounts for payments, there is no virtual account numbers that can be used for online bank account based payments. Customers in many countries do not have a debit card or credit card access or facility or have to pay additional amount to get one. However they have bank accounts and access to mobile phones with the advancement of cellular technology.

Thus, there is a need for systems and methods to allow for customers to create an on-demand virtual account number with a limited lifetime for single use which is communicated over mobile devices for immediate use for payments associated with a bank account which can be used for online purchasing, Peer to Peer Payments or to manually enter or to automatically read-out at a point of sale for purchases.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems and methods of generating and processing single use virtual accounts as numeric/alpha-numeric numbers including special characters, barcodes (optical machine-readable representation of data like 2D, 3D, Matrix barcode(QR code etc.)) or NFC Data Exchange Format (NDEF) for payment transaction which are generated and transmitted to a customer's registered mobile device. The virtual account with a limited lifetime is created for the associated bank account number.

In one embodiment, the virtual account number is generated on-demand by the registered customer upon authentication which is communicated using SMS, IVR, STK, Mobile Apps, Smart Device Apps or USSD protocols and send it to the registered mobile number for immediate use for payments which can be used for fund transfer, online purchasing, Peer to Peer Payments or to manually enter or to automatically read-out at a point of sale for purchases.

Systems and methods also relate to the use of NFC Tag and NFC Device as a Payment Terminal. In another embodiment, NFC enabled ATM booths can be used as a cash withdrawal terminal in place of traditional payment cards. The system can be used to provide a payment instruction for a targeted pre-programmed NFC enabled device or Optical device installed in Vending Machine, Washing Machine, Offline Cash Dispenser Machine, Toll Collecting Machine, Ticketing Booth, Metered Taxi, Parking Lot etc. A customer generated transaction data using NFC enable device will be used to withdraw from a NFC enabled online, offline and standalone Cash Dispensing machine which will determine the authorized transaction data from the customer's NFC enable device and dispense the amount to customer.

In another embodiment, a virtual account is used in different channels or devices to pay to the merchant. The system generates a virtual account and transfers it to customer's mobile device as a series of numbers, or a barcode (optical machine-readable representation of data like 2D, 3D, or matrix barcode (QR code etc.)) or binary format. Then the customer can use the data received in their device for purchases in a vending machine, parking lot, metered taxi, toll or bill collection booth, shopping cart, an online or offline cash dispenser machine or any Point Of Sale (POS) device enabled with NFC, RFID or Optical Readers to read and interpret the data provided from the customer's phone device for processing a payment transaction.

In another embodiment, merchants may preload/pre-populate a product or services offered via an online website, shopping carts, vending machine or store shelves with a unique product code or identification code with the associated monetary value.

In another embodiment, merchants generate an on-demand identification code for invoice/receipts for payment by the customers by authenticating the transaction. Customers can generate a virtual account number for payment by sending the product code to the virtual account system for the identification code. The virtual account is generated based on the associated monetary value. Once authenticated, the customer receives the virtual account number in their mobile device which may be represented by any representable code or characters and transmitted or inputted into a merchant POS system using appropriate input hardware. Using the virtual account, the system replaces traditional hardware based POS devices for payment processing by creating an alternative path to cash, cheque and coin payments.

In another embodiment, the system facilitates purchases through SMS, USSD and smart apps using product code only. The merchants are able to create a product catalogue and do necessary marketing activities with the product codes so that customers will get the product information with product code and a secure way to purchase it instantly.

In another embodiment, the system will provide facility to withdraw cash from an ATM Booth using NFC Technology or Optical Readers. The device enables the ATM to read, validate and process data from the supported Smart Phone. After proper authentication the cash will be dispensed to the client from the ATM.

In another embodiment, the system can be used to provide a payment instruction for a targeted pre-programmed NFC enabled device or Optical device installed in Vending Machine, Washing Machine, Offline Cash Dispenser Machine, Toll Collecting Machine, Ticketing Booth, Parking Lot, Metered Taxi etc. The targeted device receives the payment instructions and sends to the core system for further processing. The system is a replacement of cash or coin deposit or payment to machines or booths as the payment of preferred services.

### BRIEF DESCRIPTION OF THE DRAWINGS

Following drawings in conjunction with detailed description help clarify the features and advantages of the present disclosure. In the figures, similar components are identified using the same reference label. Multiple instances of the same component in a figure are distinguished by inserting a dash after the reference label and adding a second reference label.

FIG. 1 illustrates an exemplary system and entity for virtual account number generation and processing with communication links.

FIG. 2 illustrates an exemplary method of customer registration for the service.

FIGS. 3 and 4 illustrates exemplary method of creating a virtual account and processing for payment using SMS, USSD, STK, Smart Apps or Mobile Apps.

FIGS. 5 and 6 illustrates another exemplary method of creating a virtual account and processing for payment using SMS and verification through alternative channel i.e. IVR.

FIG. 7 illustrates exemplary method of using the virtual account for peer to peer payment among registered customers.

FIG. 8 and FIG. 9 illustrates exemplary method of using virtual account or Purchase order to make payment from seller's virtual product catalog through customer's registered mobile phone and transaction initiated by the merchant.

FIG. 10 illustrates exemplary method to purchase a product using a product code through a SMS or USSD or STK or Smart Apps channel. After confirmation, the product will be delivered to customer's desired address which is set during customer registration.

FIG. 11 illustrates exemplary method to purchase a product or get a product from all kinds of Payment or Service Machines i.e. Vending Machine, Cash Dispensing Machine, Washing Machine, Toll Collecting Machine, Ticketing Booth, and Parking Lot, Metered Taxi etc. by using the generated virtual account. The vending machine or product delivery machine will have system provided hardware device to read and validate the authorized transaction for this machine only.

FIG. 12 illustrates exemplary method to ATM transaction by NFC enabled ATM devices. Where the ATM will read the requested transaction from NFC enable smart devices and authorization through the ATM's processor.

### DETAILED DESCRIPTION

The FIGURES and text below, and the various embodiments used to describe the principles of the present invention are by way of illustration only and are not to be construed in any way to limit the scope of the invention. A Person Having Ordinary Skill in the Art (PHOSITA) will readily recognize that the principles of the present invention maybe implemented in any type of suitably arranged device or system. Specifically, while the present invention is described with respect to use in certain networks and Access Points therein, a PHOSITA will readily recognize other types of networks and other applications without departing from the scope of the present invention.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by a PHOSITA to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

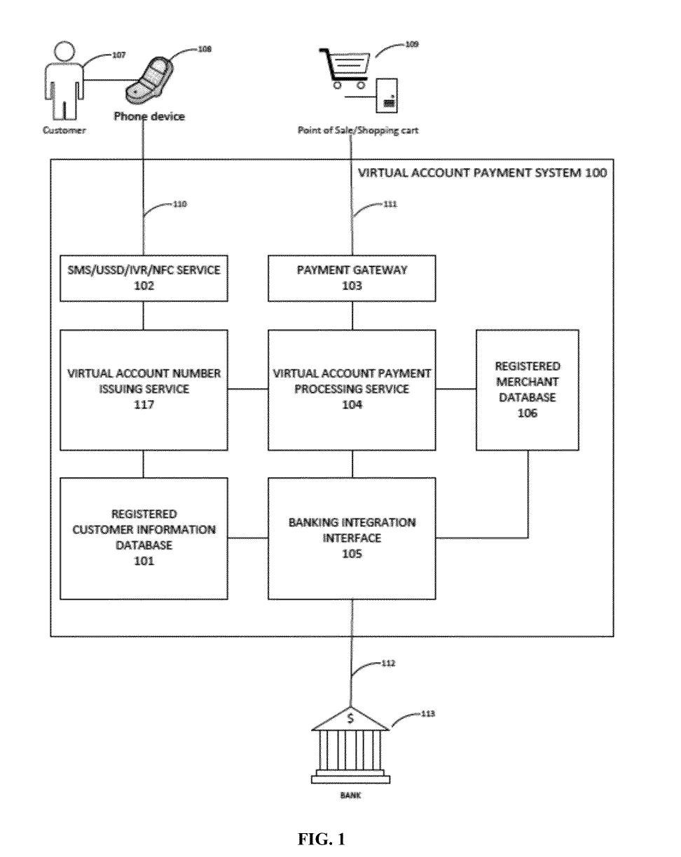

Reference is now made to FIG. 1 illustrating an exemplary virtual account payment system 100 for creating and processing virtual account number for a bank account. The system 100 comprising a multi-transport content and service delivery platform 102, payment gateway 103, virtual account issuing service 117, virtual account payment processing service 104, registered merchant database 106, registered customer information database 101, banking integration interface 105 and communication networks 110, 111, and 112. FIG. 1 further illustrates the entities connected or using the system comprising customer 107, mobile communication device 108, point of sale 109 and Banking institution 113.

Customer 107 is an individual with a registered bank account and registered phone number 108 enrolled in the registered Customer Information Database 101 whose information is validated during enrollment. In some embodiments an individual may register more than one bank account. That is, the system may aggregate and monitor multiple bank accounts.

Multi-transport content and service delivery platform 102 is an interface and system to communicate between Virtual account number issuing service 117 and the Customer 107 via communication device with phone number 108. Multi-transport content and service delivery platform 102 is capable of servicing the request using Short Message Service (SMS)/Unstructured Supplementary Service Data (USSD)/SIM Toolkit (STK), Interactive Voice Response (IVR) protocols or any other service protocols that can communicate with phone device with the registered phone number.

Communication device with phone number 108 includes, but is not limited to, a cell phone, a smart phone, a desktop, laptop, palmtop, or tablet computing device, an internet access device, a personal digital assistant, or another device capable of receiving a SMS, voice call or any other supported communications which can be contacted and associated with registered phone number, including combinations thereof.

Point of Sale 109 is configured to process virtual account number for payments by the registered merchant who is pre-enrolled in Registered Merchant Database 106, and can comprise a computing device or computing platform such as, but not limited to, a point-of-sale device, a browser, software application accessible on a desktop, laptop, palmtop, or tablet computing device, a personal digital assistant, an internet access device, a cell phone, a smart phone, or another device capable of receiving an input and running an integrated system for payment processing, including combinations thereof.

Point of Sale 109 communicates to Payment Gateway 103 which is the interface for the Virtual Account number payment processing service 104 which is the system to process; validate virtual account number and other related information while interacted with all the other system/services of the payment system.

Banking Integration Interface 105 is an interface or a system for processing financial transactions with Banking Institution 113.

Communication networks 110, 111 and 112 can comprise a wired and/or wireless communication network, and can further comprise processing nodes, routers, gateways, and physical and/or wireless data links for carrying data among various network elements, including combinations thereof, and can include a local area network, a wide area network, and an internetwork (including the Internet). Wired network protocols that may be utilized by the communication network include, but are not limited to, Transfer Control Protocol (TCP), Internet Protocol (IP), Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication networks 110, 111 and 112 may also comprise a wireless network, including base stations, wireless communication nodes, telephony switches, internet routers, network gateways, computer systems, communication links, or some other type of communication equipment, and combinations thereof. Wireless network protocols that may be utilized by the communication network may include, but are not limited to, code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Worldwide Interoperability for Microwave Access (WiMAX), and Third Generation Partnership Project Long Term Evolution (3GPP LTE). Communication networks 110, 111 and 112 may also comprise combinations of the foregoing. Other network elements may be present in the communication network which are omitted for clarity, including additional processing nodes, routers, gateways, and physical and/or wireless data links, and in the case of wireless communications systems may further include base stations, base station controllers, gateways, call controllers, and location registers such as a home location register or visitor location register.

Other network elements may be present to facilitate communication in communication system 100 which are omitted for clarity, including additional processing nodes, routers, gateways, and physical and/or wireless data links for carrying data among the various network elements, and in the case of wireless communications systems may further include base stations, base station controllers, gateways, mobile switching centers, dispatch application processors, and location registers such as a home location register or visitor location register.

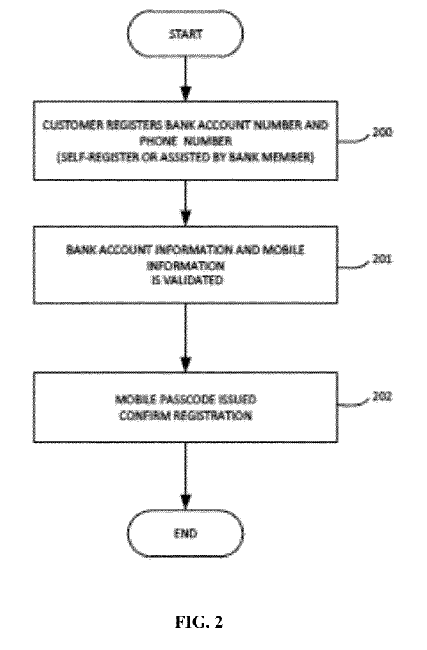

FIG. 2 illustrates an exemplary method of customer registration for the service. Operation 200, customer 107 registers his/her bank account information belonging to a participating banking institution or bank institutions. The registration also comprises of a phone number associated with a mobile phone device or combinations thereof. The enrollment can be self-registration by the customer 107 or an authorized independent agent or bank member with access to the enrollment system.

In Operation 201, bank account information is validated with the banking institution or institutions through the predefined procedure, process and systems. Phone number is validated by predefined procedure, process and systems which might include sending and receiving SMS messages and/or IVR assisted phone calls and/or USSD and/or Smart Apps.

In Operation 202, customer 107 is issued or assisted in creating a PassCode for future authentication to the system to generate or process virtual account number.

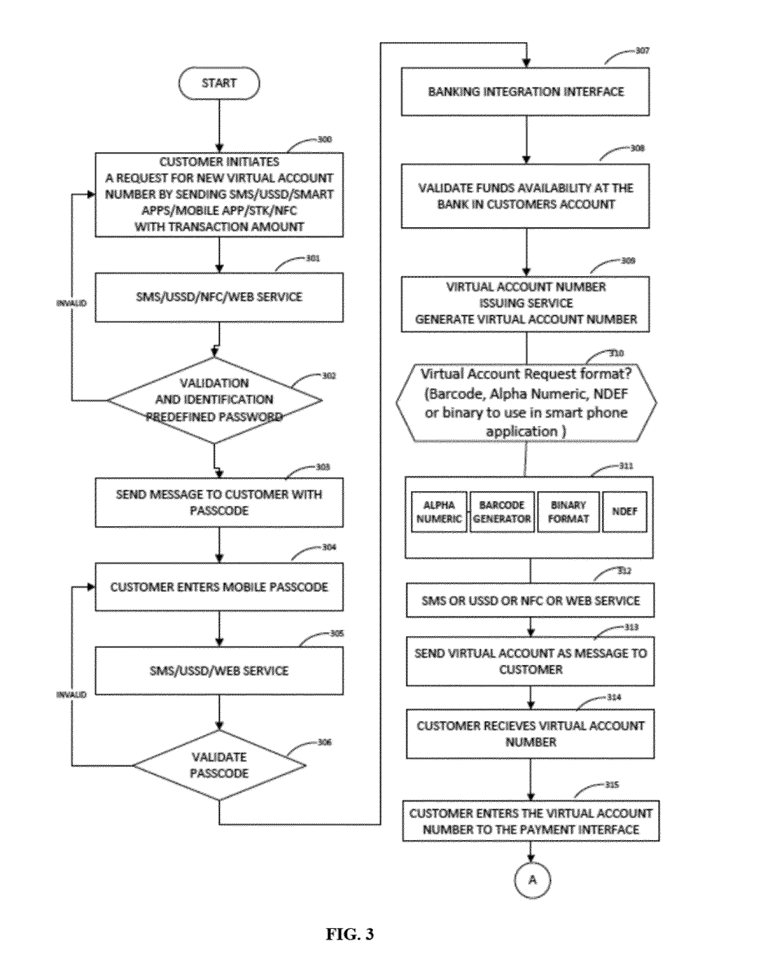

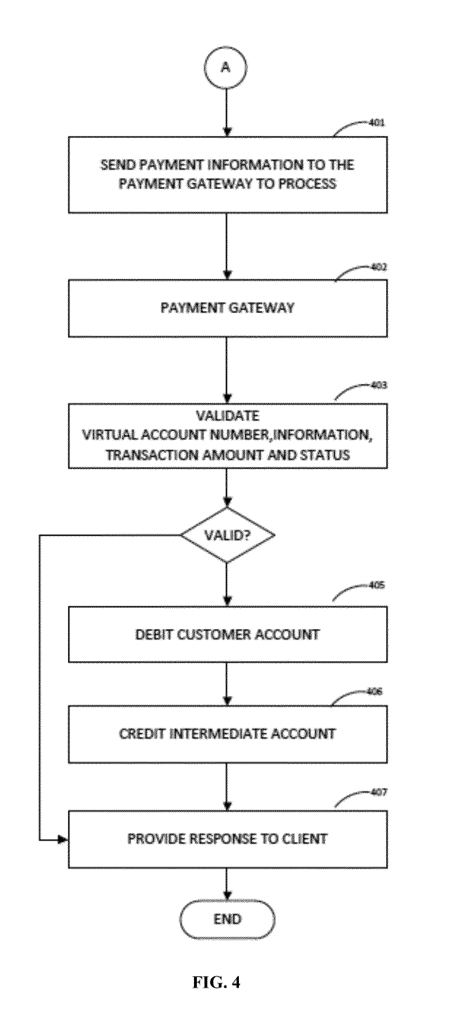

Reference is now made to FIGS. 3 and 4 which illustrate exemplary methods of creating a virtual account number and processing for payment using SMS or USSD or Smart Apps. Customer 107, who wants to pay for goods on an online shopping cart or at a retail establishment or a point of a sale, initiates a request for new Virtual Account (Operation 300). A message is sent by the customer 107 using the registered mobile phone number along with the transaction amount, predefined password and type of virtual account(N=numeric, B=Bar-code etc.). SMS or USSD or Web Service receives the message (Operation 301) and Validates the phone number, identified the customer and authenticate the provided password (Operation 302). In Operation 303, a message is sent to the customer 107 prompting for mobile passcode to authenticate. Customer 107 enters the pass-code and sends a message (Operation 305) to multi-transport content and service delivery platform 102 to validate the passcode/pin. Once passcode is validated, the system validates the funds availability at the bank or banks through the integrated interface for the validated customer bank account. If funds are available, a virtual account is generated.

In Operation 309, virtual account issue service 117 will generate a virtual account which can be numeric or alpha numeric and preferably range from 10 to 20 characters or bar-code or binary format according to customer's request. The virtual account format might have additional security information like a security code, expiry date, expiry time, transaction amount, transaction information and combinations thereof.

The generated virtual account is sent to the customer 107 via SMS or USSD or Web Services (operation 311). Customer receives the virtual account number (operation 313) and enters or automatically read-out into the point of sale interface, which can be an online shopping cart or any a payment terminal (Operation 315). The virtual account number along with other payment and transaction information is submitted to payment gateway 103 for processing. (Operation 401 and 402).

In Operation 403, the Virtual Account Payment Processing Service 104 validates the virtual account number, merchant information, customer information, transaction amount, status of the virtual account number. If the information is valid, customer bank account will be debited (Operation 405) and funds will be credited to the intermediate bank account (Operation 406). A confirmation message will be sent back (Operation 407) to the point of sale where the transaction originated from.

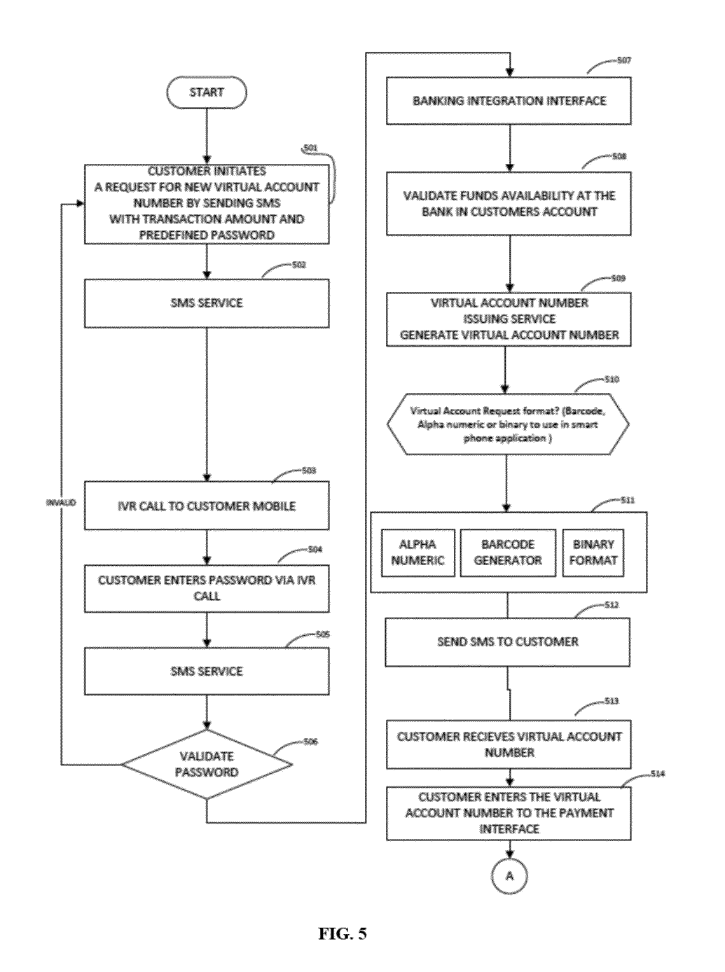

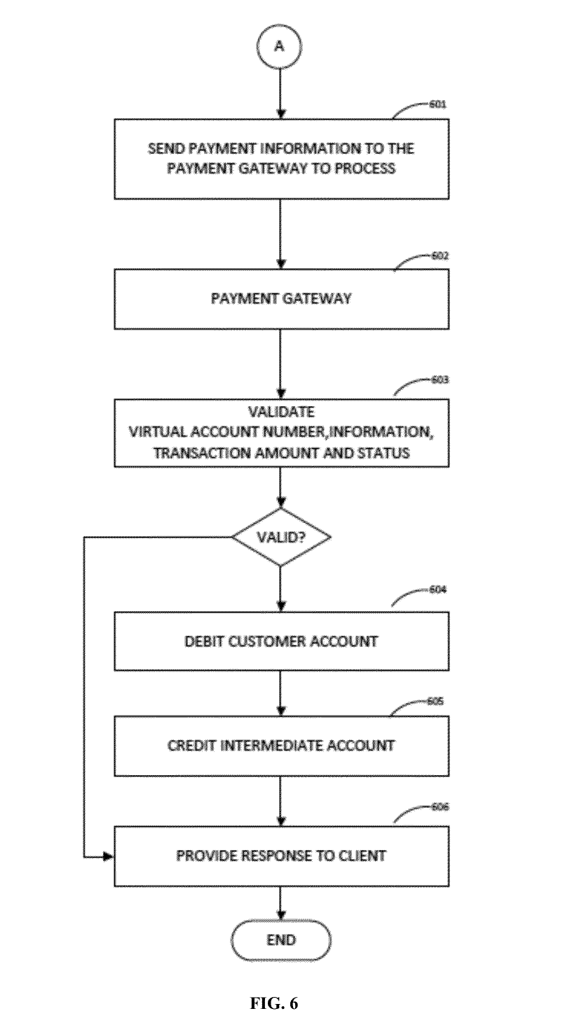

Reference is now made to FIGS. 5 and 6 that depict an exemplary method of creating a virtual account number and processing for payment using SMS and IVR combination. The validation process to create the virtual account number is sent to customer 107 as an SMS after validating predefined password using automated IVR system.

In Operation 504, the automated IVR will call the registered mobile number to validate the predefined password after initialization the request for virtual account by the customer's registered phone. In this case, a customer 107 will enter predefined password when an IVR asks customer 107 to enter the password, remaining processes after validation of the predefined password will be similar to the operations described in FIGS. 3 and 4.

The virtual account numbers for the bank accounts may be used person to person payment and is not limited to customer to merchant transactions. One registered customer can provide the virtual account to another registered customer instead.

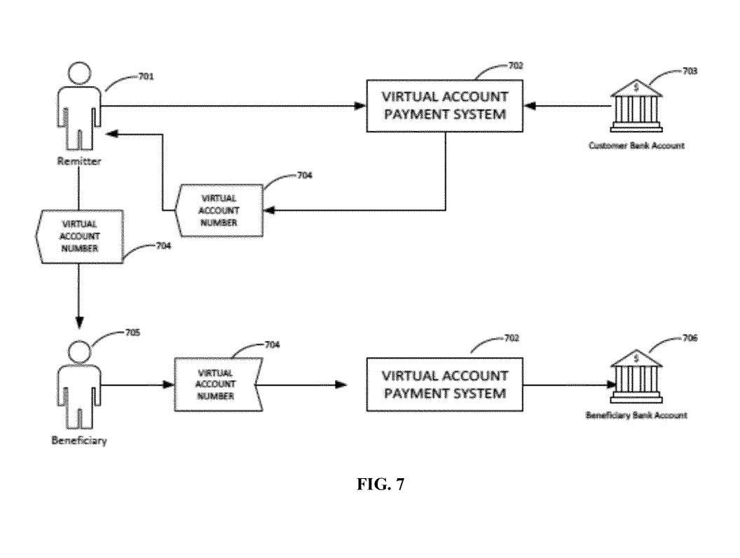

FIG. 7. illustrates an exemplary method of using the virtual card for peer to peer payment among registered customers. Registered customer/remitter 701 can generate a virtual account number and provide the virtual account number 704 to another registered customer/beneficiary 705 who is the beneficiary to redeem the virtual account number and transaction amount will be credited into the beneficiaries account upon validation. This enables the system to be used for peer to peer payments using SMS or USSD or Smart Apps and Virtual account number eliminating Checks and exposure of bank account information.

Virtual account number might include a pre authorized transaction representation with a unique representational encoded algorithm to be used in vending machines or ATM or similar devices.

Virtual account number might include a pre authorized transaction representation with a unique encoded algorithmic value to be used in vending machines or ATM or similar devices.

Representation of virtual account is preferably made by 10-20 character Numeric or Alpha numeric characters. Virtual account or a preauthorized transaction can also be represented by barcode (optical machine-readable representation of data like 2D, 3D, Matrix barcode (QR code etc.)) or binary format.

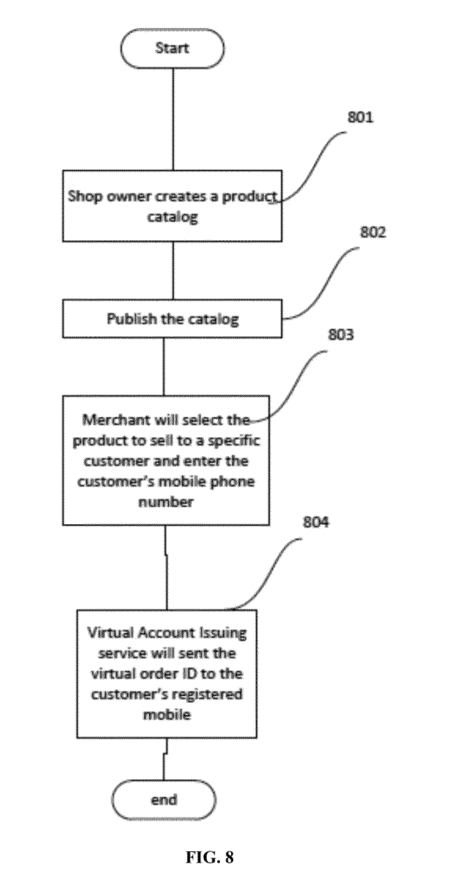

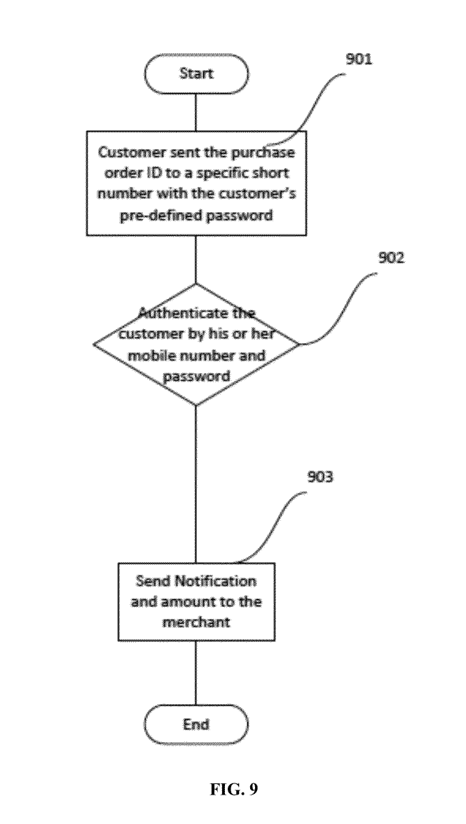

In FIGS. 8 and 9, merchant will be able maintain a catalogue in smart app or online. Merchant can offer to sell a product to person by an invitation to customer's registered mobile phone or Customer might choose a product to be purchased. Merchant will send the payment request to the customer's mobile using registered mobile phone or certified apps through SMS, USSD, STK or smart app. Customer will be authenticated by an IVR call or Smart Apps for password. After authentication the transaction will be sent for authorization. System will send confirmation messages to customer and merchant.

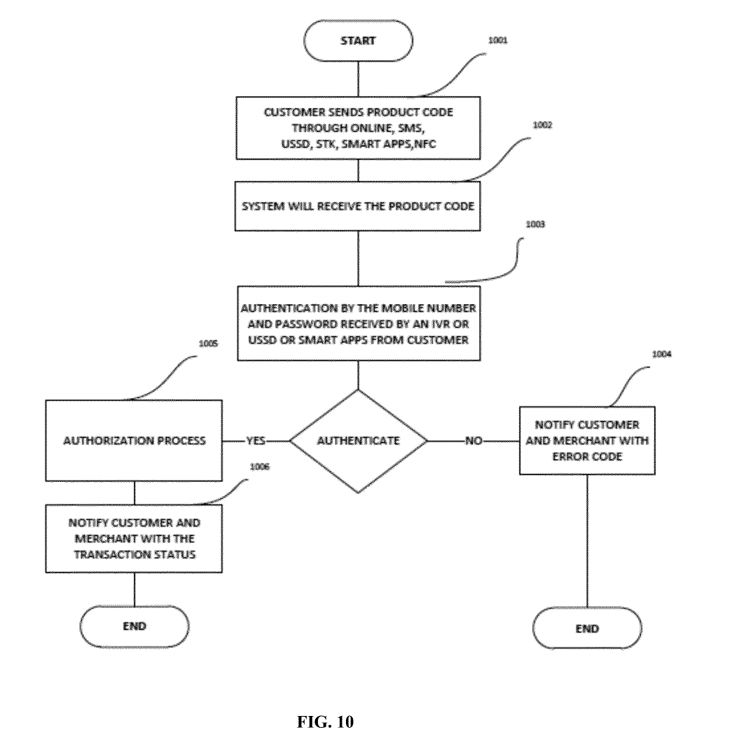

In FIG. 10, Customer will send the product code 1001 through SMS, USSD, Smart app or STK to specific number to process the purchase request. System will receive the code 1001 to process the requested transaction. System will authenticate customer 1002 by the registered mobile number and also generate an IVR call, USSD, STK or Smart Apps to customer to verify the password. After authentication, system sends the transaction for authorization. After getting the successful message from the authorization process, the system will send notification messages to both customer and merchant.

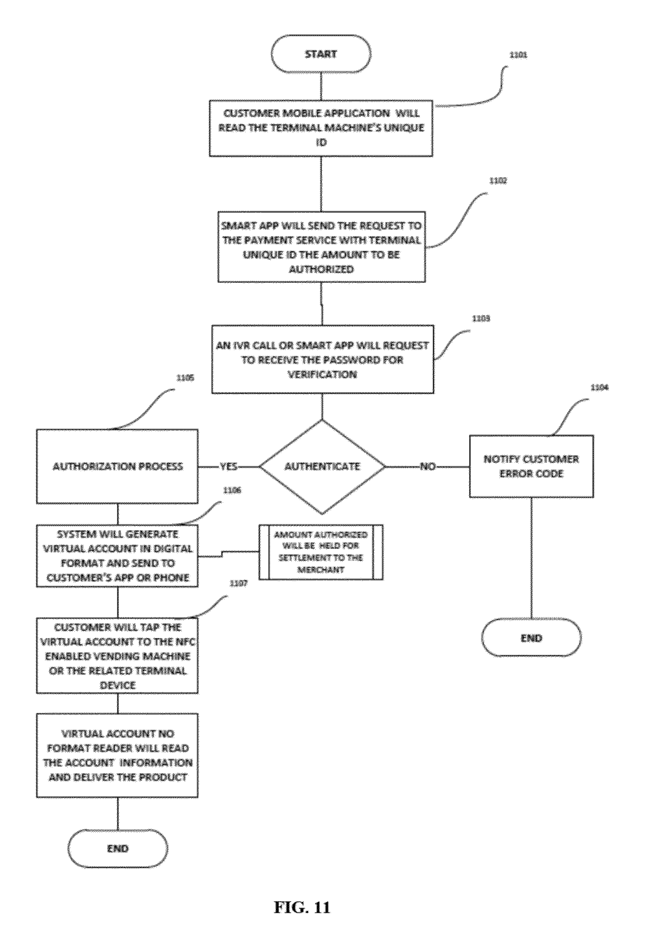

In FIG. 11, customer's mobile application will read the unique ID of Terminal device such as a like Vending Machine, Parking Lot, Metered Taxi, Toll or Bill Collection Booth, Shopping Cart, Offline Cash Dispenser Machine and POS attended or unattended stations etc. The unique id will be predefined in the core payment system and associated with a merchant account and related products if applicable. The unique information (Ex: Terminal ID) can be represented by phone readable code (Ex: QR code) or can be representational character can be input into the phone application manually. So, every machine will have a unique key to maintain or exchange data with the system through customer's smart application. Then customer will request the amount to the system by sending terminal information. System will authorize the transaction and generate a virtual account. The virtual account will be encrypted by the terminal unique key and sent to the customer to pay for the service. In the above process, an IVR call or USSD or Smart Apps will be generated from the system to customer to verify the predefined password.

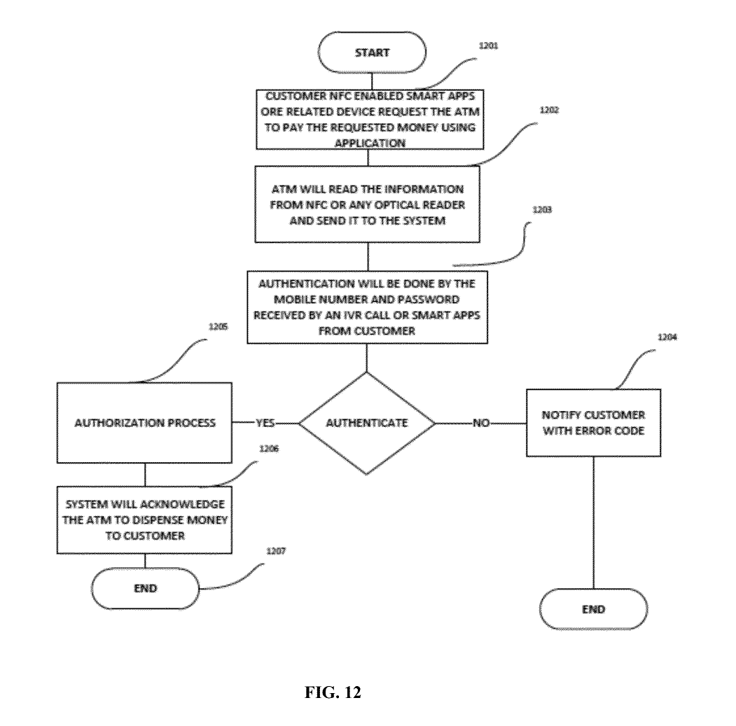

In FIG. 12, the system can be used to withdraw cash in an ATM; the ATM device will be enabled with an embedded device or an optical reader to read the request from customer's smart application. The customer will input the amount to withdraw within the ATM or the smart phone application. ATM will send the request to processor with the identification information and amount to be withdrawn. Customer will be authenticated via the mobile phone and IVR process and confirmation will be sent to the customer mobile phone and ATM. Customer will provide the authentication received to the ATM, upon validation of the authorization, the cash will be dispensed.

Unique ID's or Terminal ID's or Identification parameters embedded in the POS/Terminal/ATM machine will be a static or dynamic key or ID. The information can be entered manually or dynamically from the core payment system. It can also be an encryption key which can be used for asymmetric or symmetric encryptions and might be unique per device. The communications between the device and smart phone will be encrypted with encryption technologies to protect the integrity of data.

As another alternative, the virtual account number payment may include a recurring transaction for a specific amount to be paid in regular intervals. For example, the customer may receive services or products over a fixed number of payment intervals, such as monthly or weekly basis. Accordingly, the merchant is given authorization to charge the virtual account on the agreed upon schedule.

In some embodiments the system serves as a mediator between a user and multiple registered bank accounts.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of processing a virtual account for a payment transaction, comprising:
generating a virtual account number associated with a customer bank account for payment with a fixed transaction amount for at least one transaction, said processing initiated from a customer's authenticated mobile device;
communicating the virtual account number to the end user;
validating the virtual account for payment processing; and,
processing the virtual account number for payment and transferring funds.

2. The method according to claim 1, wherein said virtual account number is selected from the group consisting of as a series of numbers, bar-code, NDEF and binary format.

3. The method of claim 2, wherein representation of a virtual account is by 10-20 Numeric or Alpha numeric characters.

4. The method of claim 2, wherein the virtual account number is generated as barcode or binary format.

5. The method of claim 2, wherein the virtual account format is barcodes (optical machine-readable representation of data like 2D, 3D, Matrix barcode (QR code etc.)) or NFC Data Exchange Format (NDEF).

6. The method according to claim 1, wherein said processing initiated from a customer's mobile device uses SMS text message or USSD or Smart Apps or Mobile Apps or STK authenticated by a predefined passcode or generated by IVR system or other alternative channel.

7. The method of claim 1, where in the step of generating the virtual account further comprises generating the virtual account number based upon one or a combination of the merchant information, customer registration information, transaction/order information, transaction amount and/or any single or multi use parametric/identifiable information.

8. The method of claim 1, wherein validity or lifespan of the virtual account is limited to the period specified by the type of transaction and other preset parameters which can include date and time.

9. The method of claim 8, wherein validity is limited to single use of the virtual account for a payment transaction and predefined transaction amount.

10. The method of claim 1, wherein generation of the virtual account occurs when the transaction for a purchase of goods or services is initiated by the customer via registered mobile number to be used at merchant website or any other point of service.

11. The method of claim 1, wherein communication or delivery of the virtual account number is sent to a mobile device via Short Message Service (SMS)/Unstructured Supplementary Service Data (USSD)/SIM Toolkit (STK), Near Field Communication (NFC) or Interactive Voice Response (IVR) or Mobile Apps or Smart Apps.

12. The method according to claim 11, wherein said mobile device has a registered phone number.

13. The method of claim 1 wherein the system to process the virtual account which will validate, if required, comprises converting to any other associated account information and processing it for further payment based on the account association with a bank account number or financial institution and transferring funds to the merchant/beneficiary from the users account.

14. The method of claim 1 further comprising creating virtual mobile shop/e-store through any smart device so that, the user can purchase or sell products or services from the virtual catalogue through a mobile device.

15. The method according to claim 14, wherein said mobile device is a registered mobile phone.

16. The method of claim 1 further comprising, purchasing a product or service with single or multiple product code through a communication channel selected from the group consisting of SMS, USSD, NFC, Mobile Apps or Smart Apps and STK.

17. The method of claim 1 wherein online or offline/standalone cash withdraw or deposit is facilitated when an NFC enable device installed in the machine.

18. The method of claim 1 wherein transaction in ATM devices is initiated through a system provided embedded NFC enable device from the customer's NFC enable smart application.

19. A virtual account payment system comprising:
a multi-transport content and service delivery platform;
a payment gateway,
a virtual account issuing service,
a virtual account payment processing service,
a registered merchant database,
a registered customer information database,
a banking integration interface and,
communication networks.
